(19) United States
(12) Patent Application Publication
(10) Pub. No.: US 2016/0274681 A1
(43) Pub. Date: Sep. 22, 2016

(54) IMAGE PROCESSING SYSTEM, THE IMAGE PROCESSING DEVICE AND PROGRAM

(71) Applicant: Yoshifumi SAKURAMATA, Kanagawa (JP)

(72) Inventor: Yoshifumi SAKURAMATA, Kanagawa (JP)

(21) Appl. No.: 15/073,734

(22) Filed: Mar. 18, 2016

(30) Foreign Application Priority Data
Mar. 18, 2015 (JP) 2015-054185

(51) Int. Cl. G06F 3/038; G06F 3/0354; G06T 11/20; G06F 3/14

(52) U.S. Cl. CPC G06F 3/0386; G06F 3/14; G06F 3/03542; G06T 11/203

(57) ABSTRACT

An image processing system is provided that includes processing circuitry to calculate coordinates of a drawing apparatus adjacent to or contacting a display, determine identification information of the drawing apparatus based on the calculated coordinates, and draw an image at the calculated coordinates based on setting information that corresponds to the identification information of the drawing apparatus.

### CROSS-REFERENCE TO RELATED APPLICATION

The present application claims priority to and incorporates herein by reference the entire contents of Japanese Patent Application No. 2015-054185, filed in Japan on Mar. 18, 2015.

### BACKGROUND

1. Field

The present disclosure relates to an image processing system on which a user draws using a drawing apparatus. In more detail, without depending on a communication state between the drawing apparatus and the image processing device, the present disclosure relates to an image processing system, an image processing device, and a program that uses the drawing apparatus.

2. Discussion of the Background

Conventionally, in conferences at companies, educational organizations, administrative organizations, etc., images supplied by an information processing device such as a PC, etc. are displayed, and a drawing instruction can be given by a user.

In one conventional image processing system, an input instruction tool (e.g., a pen-like instrument) conducts coordinate input by touching a coordinate input device body (e.g., a display), as described in Japanese Patent No. 5366789. In this system, information of an input instruction is sent to the display when the input instruction tool touches the display. Further, the display controls a floodlighting period so that floodlighting by a floodlighting unit of the display does not overlap a period of emission of the input instruction tool, when the display receives the input instruction.

However, in the conventional coordinate input device, when data from the drawing apparatus cannot be received for some reason, the data cannot be drawn without an input instruction, and there is a problem that a drawing point, a short line, etc. cannot accurately be reflected for a short time.

The present disclosure relates to solving the above-described problems, without depending on a communication state between the drawing apparatus and the image processing device.

### SUMMARY

An image processing system according to the disclosed embodiments includes a coordinate calculation unit configured to calculate coordinates of a drawing apparatus emitting light, and a drawing unit configured to draw an image at the coordinates based on setting information related to identification information of the drawing apparatus. In particular, in one embodiment the image processing system includes processing circuitry configured to calculate coordinates of a drawing apparatus adjacent to or contacting a display; determine identification information of the drawing apparatus based on the calculated coordinates; and draw an image at the calculated coordinates based on setting information that corresponds to the identification information of the drawing apparatus.

By the image processing system of the present disclosure, by using the disclosed components, without depending on a communication state between the drawing apparatus and the image processing device, stable drawing by the drawing apparatus is possible.

### BRIEF DESCRIPTION OF THE DRAWINGS

The accompanying drawings are included to provide further understanding of the present disclosure, and are incorporated in and constitute a part of the specification. The drawings illustrate the embodiments and, together with the specification, serve to explain the principles of the embodiments, wherein

FIG. 1 is a figure illustrating an image processing system;

FIG. 2 is a figure illustrating a hardware structure of the image processing device 110;

FIG. 3 is a figure illustrating a functional structure of the image processing device 110;

FIG. 4 is a schematic chart illustrating a calculation method for coordinates of the drawing image;

FIG. 5A and FIG. 5B are flowcharts illustrating processing of the image processing device in one embodiment;

FIG. 6A is a flowchart illustrating processing of the image processing device in another embodiment;

FIG. 6BA and FIG. 6BB are tables associated with FIG. 6A;

FIG. 7 is a flowchart illustrating one embodiment for a verification process of the identification information of the drawing apparatus;

FIG. 8 is a figure illustrating a state transition for one embodiment of the drawing apparatus information table; and

FIG. 9A and FIG. 9B are figures for one embodiment of the setting information table and the receiving information table.

### DETAILED DESCRIPTION

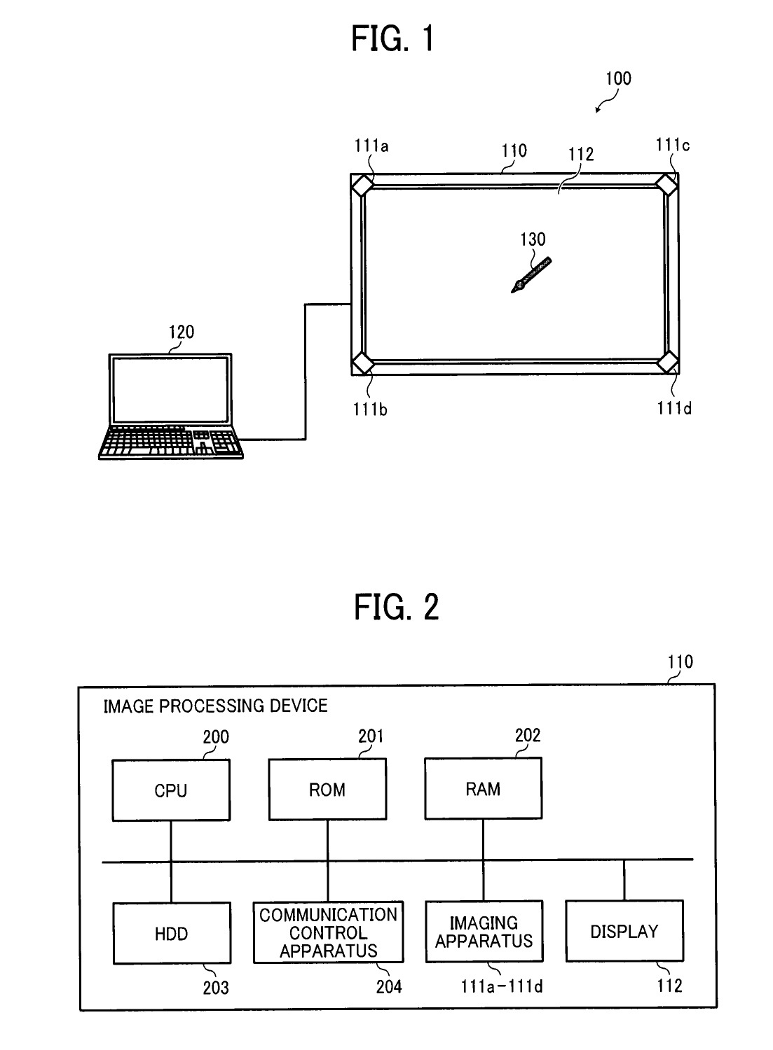

FIG. 1 illustrates an image processing system 100 in one embodiment. The image processing system 100 includes an image processing device 110, a drawing apparatus 130, and an image providing apparatus 120. The image processing device 110 is a device that can display an image provided by the image providing apparatus 120, and can perform drawing based on an instruction input by the drawing apparatus 130.

The image processing device 110 includes imaging apparatuses 111a, 111b, 111c, and 111d, and a display 112. The imaging apparatuses 111a, 111b, 111c, and 111d are arranged around an outside portion of the display 112, and can capture a surface portion of the display 112. The display 112 displays drawing images, and displays various GUIs with which the user interacts by using the drawing apparatus 130.

The drawing apparatus 130 includes an emission unit that emits light. When a tip portion of the drawing apparatus 130 contacts an object, the emission unit emits light. At the same time, the emission unit wirelessly sends identification information of the drawing apparatus to the image processing device 110 using a wireless communication system.

The image providing apparatus 120 is an information processing apparatus that provides images that are displayed on the display 112 of the image processing device 110. The image providing apparatus 120 provides a target image to display to the image processing device 110 by wired or wireless communication.

FIG. 2 is a figure illustrating a hardware structure of the image processing device 110. By referring to FIG. 2, the hardware elements of the image processing device 110 will be described below.

The image processing device 110 includes a CPU 200, a ROM 201, a RAM 202, a hard disc drive (HDD) 203, a network interface (I/F) 204, imaging apparatuses 111a, 111b, 111c, and 111d, and a display 112.

The CPU 200, which is an example of processing circuitry, executes a program to implement the functionality of the present disclosure. The ROM 201 is a nonvolatile memory on which data of a boot program, etc. is stored. The RAM 202 is a nonvolatile memory that provides memory required to execute the program. The HDD 203 is a nonvolatile memory on which the program and the output data of the program, etc. is saved. The communication control apparatus 204 is an apparatus that controls communication between the image providing apparatus 120 and the drawing apparatus 130. The CPU 200 implements the functionality described below on the image processing device 110 by acquiring the program from the HDD 203, expanding the program in the RAM 202, and executing the program.

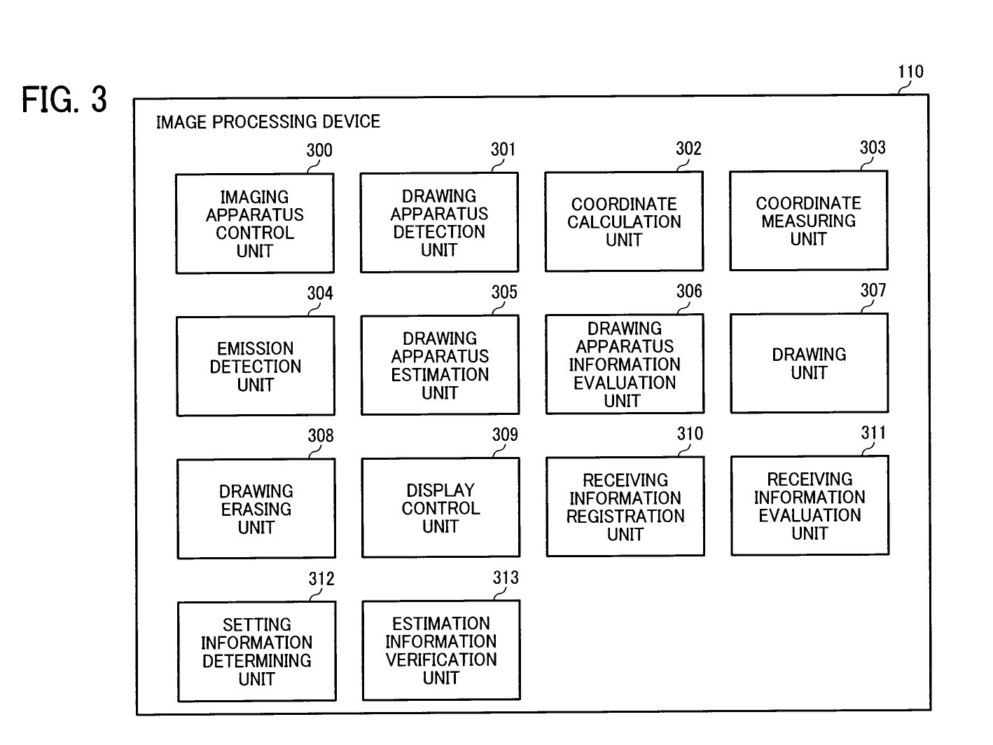

FIG. 3 is a figure illustrating the functional structure of the image processing device 110. By referring to FIG. 3 below, the functionality of the image processing device 110 will be described.

The image processing device 110 includes imaging apparatus control unit 300, a drawing apparatus detection unit 301, a coordinate calculation unit 302, a coordinate measuring unit 303, an emission detection unit 304, a drawing apparatus estimation unit 305, a drawing apparatus information evaluation unit 306, a drawing unit 307, a drawing erasing unit 308, a display control unit 309, a receiving information registration unit 310, a receiving information evaluation unit 311, a setting information determining unit 312, and an estimation information verification unit 313.

In one embodiment, the above functional units are implemented by the CPU executing the program expanding in the RAM 202. In other embodiments, the functional units may be realized by a semiconductor integrated circuit such as an ASIC.

The imaging apparatus control unit 300 controls the imaging apparatuses 111a, 111b, 111c, and 111d. The imaging apparatus control unit 300 generates captured images by an image capturing process using the imaging apparatuses 111a, 111b, 111c, and 111d.

The drawing apparatus detection unit 301 detects that the drawing apparatus 130 is close to the display 112 by determining whether a shadow of the object is included in the captured image or not.

The coordinate calculation unit 302 calculates coordinates that indicate a position of the display 112 when the object, such as the drawing apparatus 130, is close to or contacts the display 112. The coordinate calculation unit 302 calculates the coordinates of the drawing apparatus 130 that is emitting light by contacting the display 112 by using the captured images generated by the imaging apparatuses 111a, 111b, 111c, and 111d.

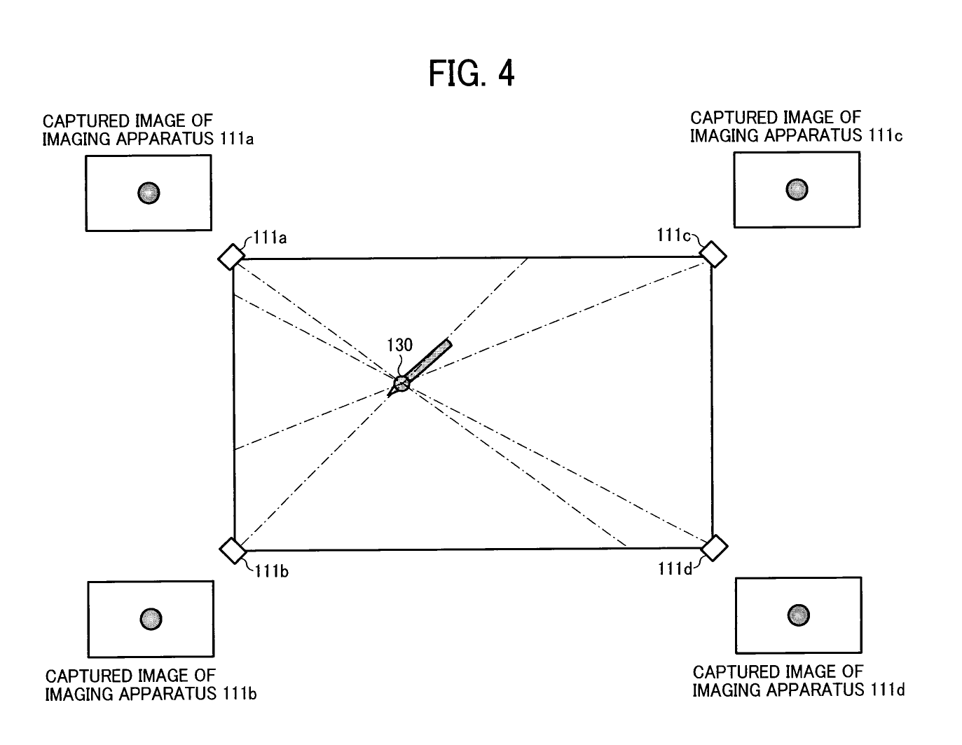

The captured images of imaging apparatuses 111a, 111b, 111c, and 111d include, respectively, an emission portion of the drawing apparatus 130, as illustrating in FIG. 4. The coordinate calculation unit 302 calculates a straight line connecting a central point of the emission portion included in the captured image of each imaging apparatus and a central point of each imaging apparatus. Next, the coordinates of the drawing apparatus are calculated from the point where those straight lines cross.

The coordinate measuring unit 303 counts a number of coordinates of the drawing apparatus 130 that are saved in the drawing apparatus information table, which registers information relating to the drawing apparatus 130.

The emission detection unit 304 determines whether the drawing apparatus 130 emits light or not by determining whether emission of the drawing apparatus 130 is included in the captured images of apparatuses 111a, 111b, 111c, and 111d or not.

The drawing apparatus estimation unit 305 estimates identification information of the drawing apparatus that is emitting light by contacting the display 112.

The drawing apparatus information evaluation unit 306 evaluates information related to the drawing apparatus 130 that is registered in the drawing apparatus information table.

The drawing unit 307 draws an image on the display 112 based on the coordinates of the drawing apparatus 130. The drawing unit 307 changes a pixel value corresponding to the coordinates of the drawing apparatus 130 to a predetermined value based on setting information related to a type of drawing assigning to the drawing apparatus 130 through display control unit 309, and draws on the display 112. The drawing erasing unit 308 erases the drawn image through display control unit 309.

The display control unit 309 controls the display 112 of the image processing device 110. The display control unit 309 conducts displaying and erasing of the drawn image, and displays a predetermined message in response to an instruction of the drawing unit 307 or the drawing erasing unit 308, etc.

The receiving information registration unit 310 is a device that saves the identification information of the drawing apparatus received from the drawing apparatus 130 in a receiving information table, which registers the received information.

The receiving information evaluation unit 311 evaluates the identification information of the drawing apparatus as received information.

The setting information determining unit 312 verifies the identification information of the drawing apparatus estimated by the drawing apparatus estimation unit 305.

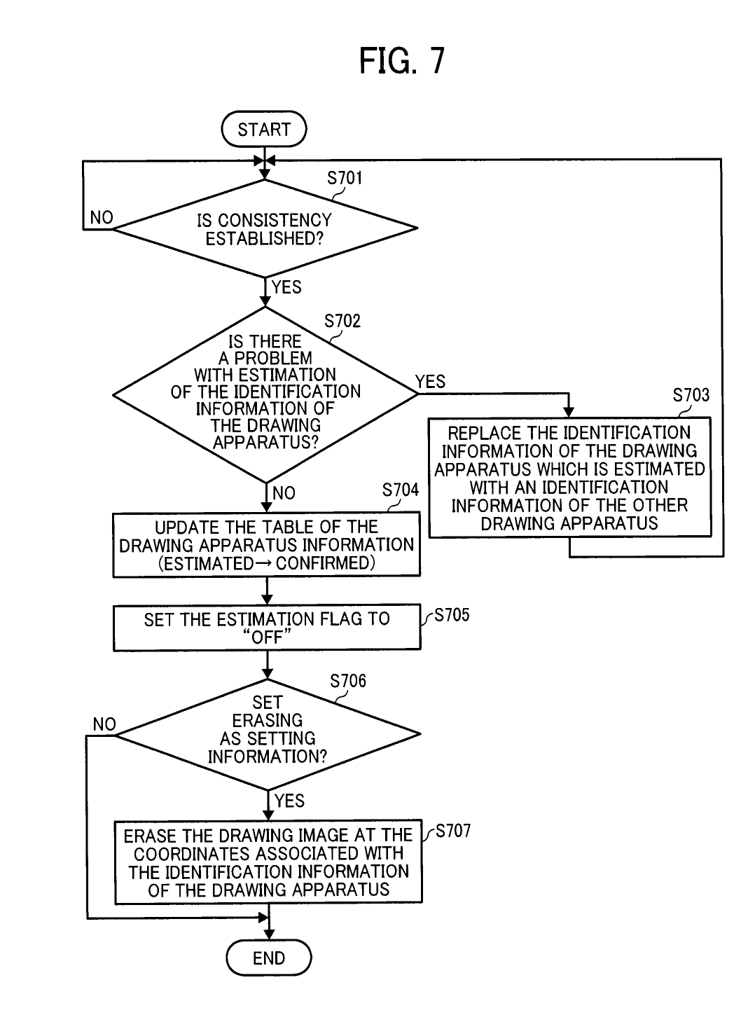

The estimation information verification unit 313 verifies the identification information of the drawing apparatus registered in the drawing apparatus information table as estimation information. The process performed by the estimation information verification unit 313 is described in detail below with respect to FIG. 7.

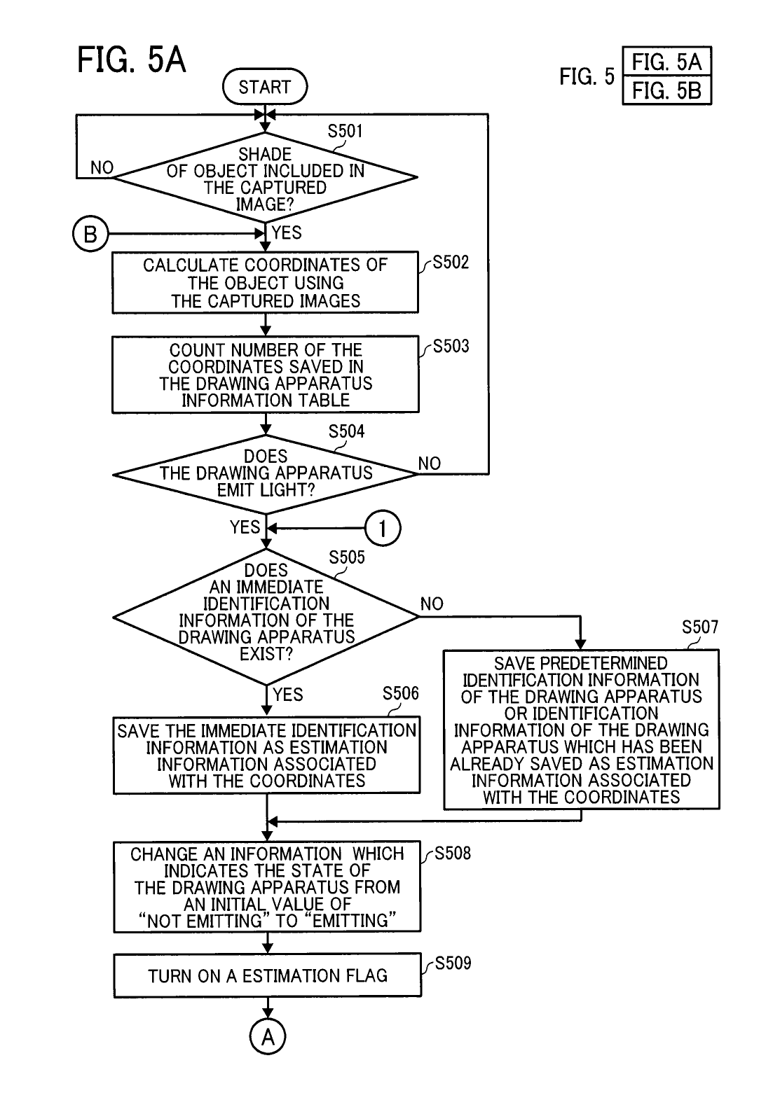

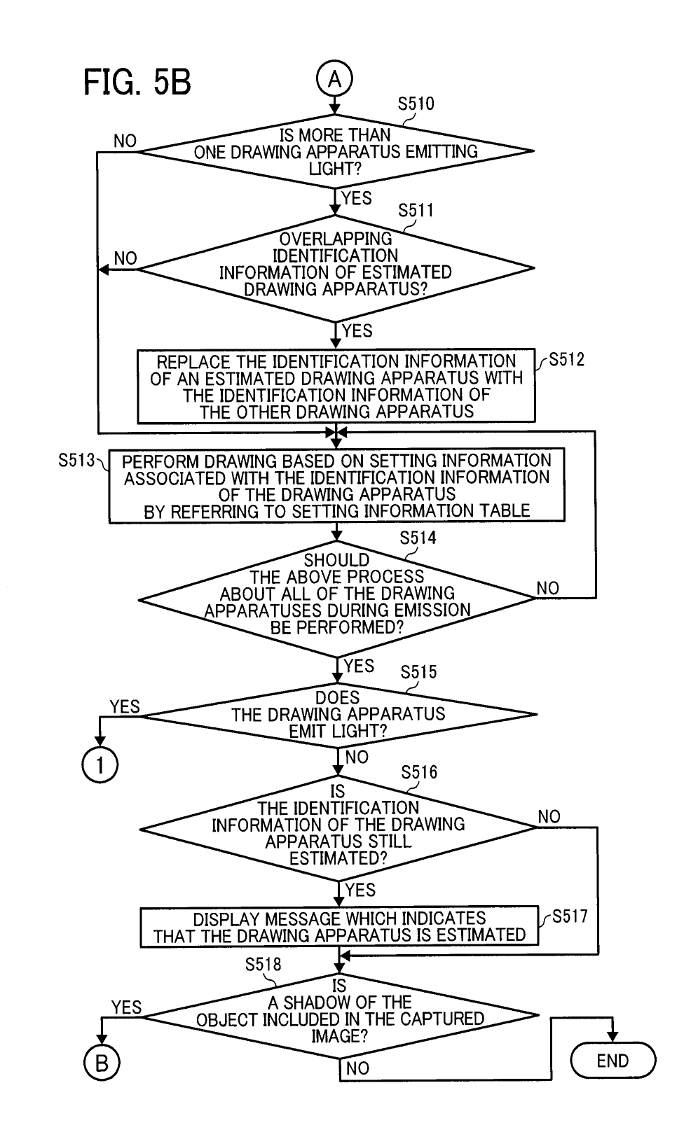

FIG. 5A and FIG. 5B are flowcharts illustrating one embodiment of a process performed by the image processing device. By referring to FIG. 5A and FIG. 5B below, the drawing process on the display 112 using the captured images generated by the imaging apparatuses 111a, 111b, 111c, and 111d is described.

The process of FIG. 5A starts by the generation of four captured images by the imaging apparatuses. At step S501, the drawing apparatus detection unit 301 determines whether or not a shadow of an object is included in the captured images. If the shadow of an object is not included in the captured images (NO at step S501), the process of step S501 is conducted iteratively. On the other hand, when the shadow of an object is included in the captured images (YES at step S501), the process proceeds to step S502.

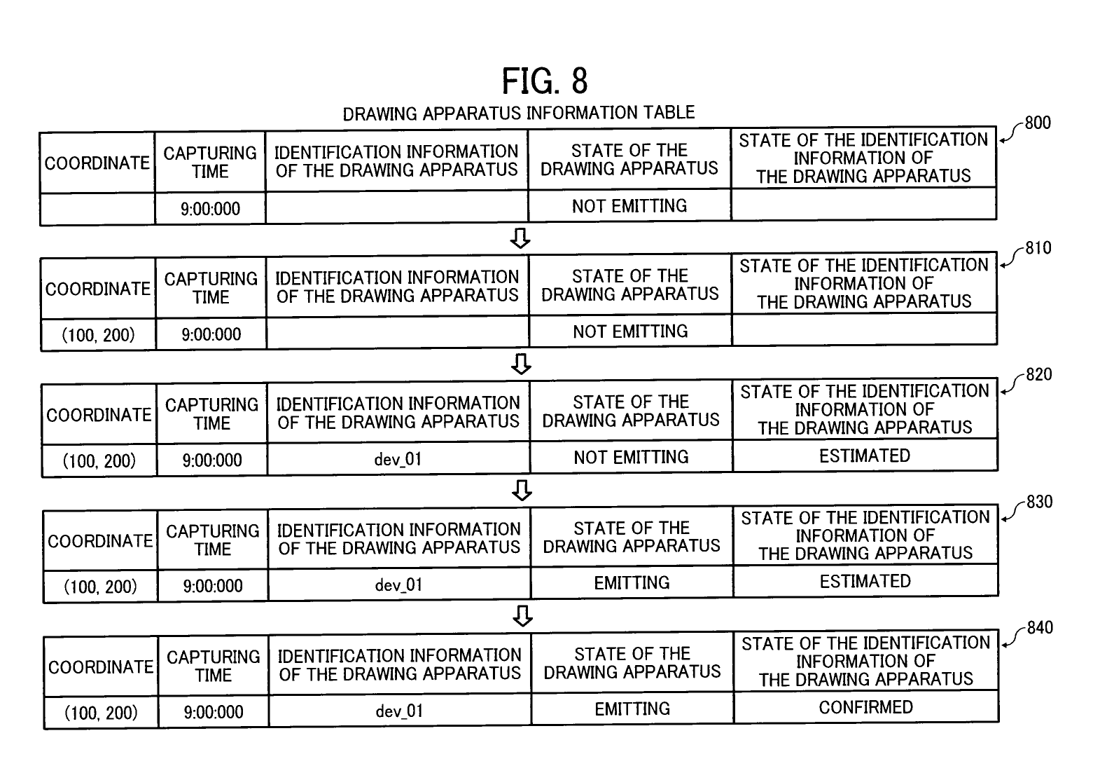

At step S502, the coordinate calculation unit 302 calculates the coordinates of the object using the captured images, and the calculated coordinates are saved in the drawing apparatus information table illustrated in FIG. 8, in association with the capturing time. If shadows of multiple objects are included in the captured images, the coordinate calculation unit 302 calculates the coordinates of each object.

At step S503, the coordinate measuring unit 303 counts the number of coordinates of the drawing apparatus 130 that are saved in the drawing apparatus information table in step S502. At step S504, the emission detection unit 304 determines whether the drawing apparatus emits light by determining whether or not emission of the drawing apparatus is included in the next captured image or not. If the drawing apparatus does not emit light (NO at step S504), the process returns to step S501. Further, the next captured image is processed in the process of step S501. On the other hand, if the drawing apparatus emits light (YES at step S504), the process proceeds to step S505.

At step S505, the drawing apparatus estimation unit 305 determines whether immediate identification information saved in the drawing apparatus information table exists or not, based on a time of detecting emission of the drawing apparatus at step S504. In more detail, the drawing apparatus estimation unit 305 collates a time detecting emission of the drawing apparatus and the capturing time registered in the drawing apparatus information table, specifies identification information of the drawing apparatus within a predetermined time that is a difference of those times as identification information of the drawing apparatus. In one embodiment, it is possible to adopt a time that corresponds to a cycle of the imaging apparatuses 111a, 111b, 111c, and 111d as the predetermined time.

If the immediate identification information of the drawing apparatus exists (YES at step S505), the process proceeds to step S506. At step S506, the drawing apparatus estimation unit 305 associates the immediate identification information of the drawing apparatus with the coordinates calculated at step S502 as estimation information, and saves the information in the drawing apparatus information table. In more detail, the drawing apparatus estimation unit 305 saves estimation information as immediate identification information of the drawing apparatus by setting the state of the identification information of the drawing apparatus to “ESTIMATED” in relation to the immediate identification information of the drawing apparatus in the drawing apparatus information table, as shown in the drawing apparatus information table 820 in FIG. 8.

On the other hand, when identification information of the immediate drawing apparatus does not exist (NO at step S505), the process proceeds to step S507. At step S507, the drawing apparatus estimation unit 305 associates predetermined identification information of the drawing apparatus with the coordinates calculated in step S502 and saves the information as estimation information in the drawing apparatus information table. In one embodiment, if identification information of the drawing apparatus is not registered in the drawing apparatus information table, the drawing apparatus estimation unit 305 saves predetermined identification information of the drawing apparatus. On the other hand, when identification information of the drawing apparatus is registered in the drawing apparatus information table, the drawing apparatus estimation unit 305 saves the current identification information of the drawing apparatus out of the registered identification information of the drawing apparatus.

At step S508, the drawing apparatus estimation unit 305 changes information indicating the state of the drawing apparatus in relation to the immediate identification information of the drawing apparatus in the drawing apparatus information table, such as the drawing apparatus information table 830 illustrated in FIG. 8, from an initial value of “NOT EMMITTING” to “EMITTING.”

At step S509, the drawing apparatus estimation unit 305 turns on an estimation flag that indicates estimation information has been registered. The estimation flag can be “ON” or “OFF.” When the estimation flag is “ON” the process of FIG. 7 will be performed. When the estimation flag is “OFF,” the process of FIG. 7 will not be performed.

At step S510, the drawing apparatus information evaluation unit 306 determines whether more than one drawing apparatus emits light or not based on the evaluation at step S504. When more than one drawing apparatus does not emit light (NO at step S510), the process proceeds to step S513. On the other hand, when more than one of the drawing apparatuses emit light (YES at step S510), the process proceeds to step S511.

At step S511, the drawing apparatus information evaluation unit 306 refers to the drawing apparatus information table and determines whether the estimated identification information of the drawing apparatus overlaps or not. In particular, the estimated identification information overlaps when two or more identifiers of respective drawing apparatuses are assigned to the same coordinates at the same time.

When the estimated identification information of the drawing apparatus does not overlap (NO at step S511), the process proceeds to step S513. On the other hand, when the estimated identification information of the drawing apparatus overlaps (YES at step S511), the process proceeds to step S512.

At step S512, the drawing apparatus information evaluation unit 306 replaces the identification information of the drawing apparatus with the another identification information of the drawing apparatus from the estimated identification information of the drawing apparatus. In one embodiment, the drawing apparatus information evaluation unit 306 replaces the identification information of the drawing apparatus with the predetermined identification information of the drawing apparatus or the other identification information of the drawing apparatus registered in the drawing apparatus information table.

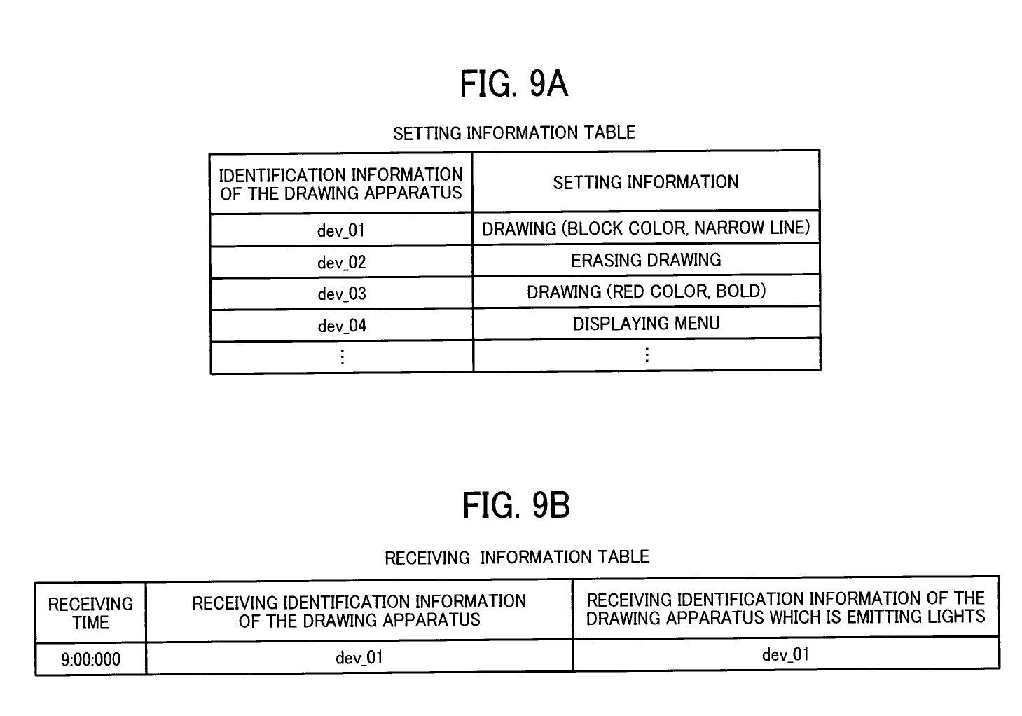

At step S513, drawing unit 307 refers to the setting information table, e.g., such as illustrated in FIG. 9A, and obtains setting information associated with identification information of the drawing apparatus that is registered in the drawing apparatus information table as estimation information. Further, the drawing unit 307 draws at the coordinates associated with the identification information of the drawing apparatus based on the setting information.

At step S514, the drawing unit 307 determines whether or not to perform the drawing process of step S513 for all of the drawing apparatuses that are emitting light. When determining not to perform the drawing process for all of the drawing apparatuses (NO at step S514), the process returns to step S513. On the other hand, when determining to conduct the drawing process for all of the drawing apparatuses, the process proceeds to step S515.

At step S515, the emission detection unit 304 determines whether or not the drawing apparatus emits light by determining whether or not emission is included in the next captured image of the drawing apparatus. When it is determined that the drawing apparatus emits light (YES at step S515), the process proceeds to step S505. On the other hand, when it is determined that the drawing apparatus does not emit light (NO at step S515), the process proceeds to step S516.

At step S516, the drawing apparatus information evaluation unit 306 determines whether or not identification information of the drawing apparatus, which is registered in the drawing apparatus information table, is estimation information. In more detail, the drawing apparatus information evaluation unit 306 references the drawing apparatus information table and determines whether or not identification information of the drawing apparatus is still identification information by determining whether or not the state of identification information of the drawing apparatus has the value “ESTIMATED,” or whether the estimation flag is “ON”.

When identification information of the drawing apparatus that is registered in the drawing apparatus information table is not estimation information (NO at step S516), the process proceeds to step S518. On the other hand, when identification information of the drawing apparatus that is registered in the drawing apparatus information table is estimation information (YES at step S516), the process proceeds to step S517. At step S517, the display control unit 309 displays a message on the display 112 that shows that the identification of the drawing apparatus is estimated.

At step S518, the drawing apparatus detection unit 301 determines whether a shadow of the object is included in the captured image or not. When a shadow of the object is included in the captured image (YES at step S518), the process proceeds to step S502. On the other hand, when the shadow of the object is not included in the captured image (NO at step S518), the process ends.

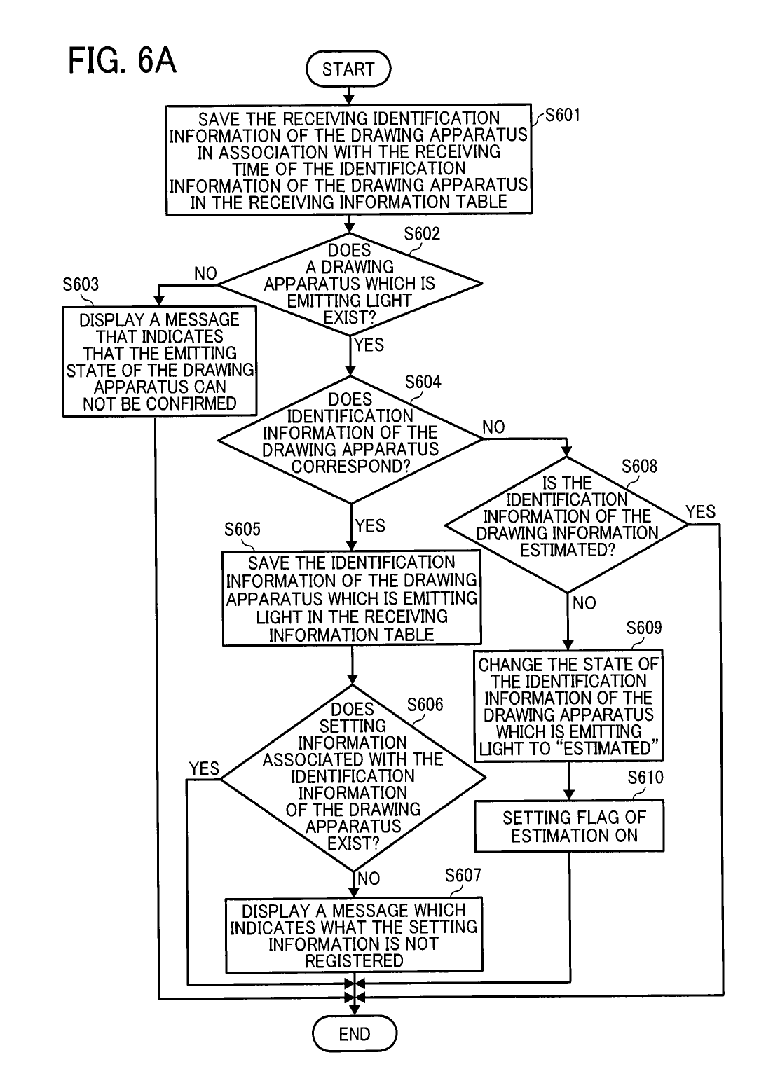

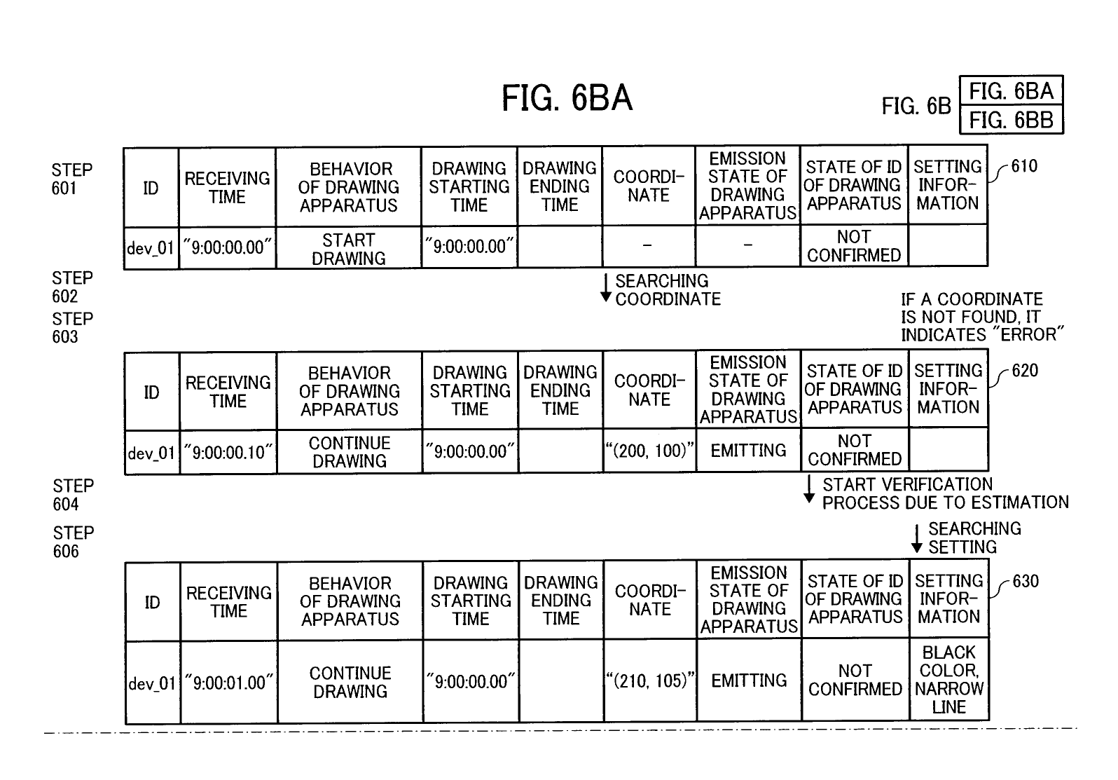

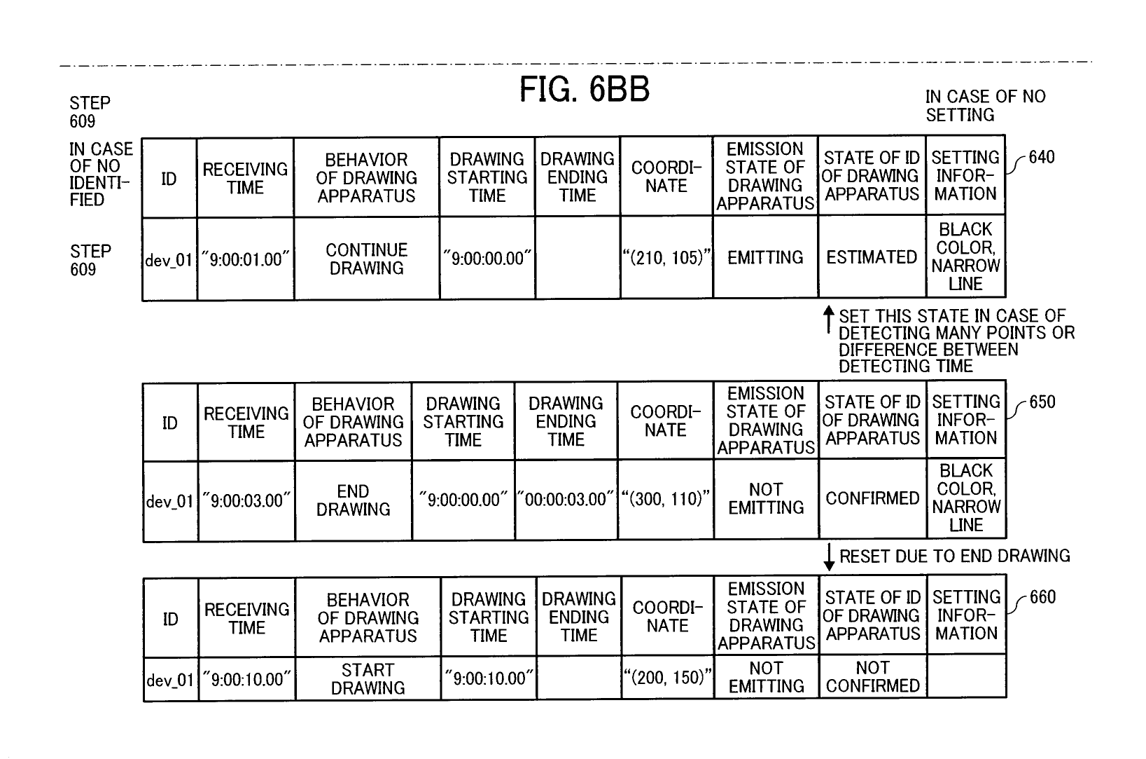

FIG. 6A is a flowchart illustrating another embodiment of a method performed by the image processing device of the present disclosure. The process of FIG. 6A is performed when the image processing device 110 receives identification information of the drawing apparatus from the drawing apparatus 130. In addition, FIG. 6BA and FIG. 6BB are tables associated with the process of FIG. 6A.

At step S601, the receiving information registration unit 310 saves, in the receiving information table, the identification information of the drawing apparatus, which the image processing device 110 receives from the drawing apparatus 130, in association with the receiving time of the identification information of the drawing apparatus, as illustrated in table 610 in FIG. 6BA and FIG. 9B. At step S601 when the process starts, the behavior of the drawing apparatus is “START DRAWING,” and the state of the ID of the drawing apparatus is “NOT CONFIRMED,” as shown in table 610.

At step S602, the emission detection unit 304 refers to the drawing apparatus information table, and determines whether or not the drawing apparatus exists in the emission state by determining whether or not identification information of the drawing apparatus is set to “EMITTING” and the behavior of the drawing apparatus changes from “START DRAWING” to “CONTINUE DRAWING,” and the state of the ID of the drawing apparatus is still “NOT CONFIRMED,” as illustrated in table 620 in FIG. 6BA.

When the drawing apparatus does not exist in the emission state (NO at step S602), the process proceeds to step 5603. At step 5603, the display control unit 309 displays a message on the display indicating that the emission state of the drawing apparatus cannot be confirmed, and then the process ends. This leads to a notice error message to the user.

On the other hand, when a drawing apparatus that is emitting light exists (YES at step S602), the process proceeds to step S604. At step S604, the receiving information evaluation unit 311 determines whether or not identification information of the drawing apparatus received from the drawing apparatus 130 and identification information of the drawing apparatus that is emitting light correspond to one another. If the identification information of the drawing apparatus corresponds (YES at step S604), the process proceeds to step S605. At step S605, the receiving information evaluation unit 311 saves identification information of the drawing apparatus in association with the received identification information of the drawing apparatus in the receiving information table.

At step S606, the setting information determining unit 312 determines whether or not the setting information associated with the identification information of the drawing apparatus exists by referring to the setting information table. When the setting information associated with the identification information of the drawing apparatus exists (YES at step S606), the process ends. For example, the setting information, “BLACK COLOR, NARROW LINE” is set and the behavior of the drawing apparatus is still “CONTINUE DRAWING,” and the state of the ID of drawing apparatus is still “NOT CONFIRMED,” as illustrated in table 630 in FIG. 6BA. On the other hand, when the setting information associated with the identification information of the drawing apparatus does not exist (NO at step S606), the process proceeds to step S607.

At step S607, the display control unit 309 displays a message on the display 112 indicating what setting information of the drawing apparatus is not registered, and the process ends. This leads to a notice error message to the user.

On the other hand, at step S604, if the identification information of the drawing apparatus is determined not to correspond (NO at step S604), the process proceeds to step S608. At step S608, the drawing apparatus information evaluation unit 306 determines whether or not identification information of the drawing apparatus that is emitting light is estimation information by referring to the drawing apparatus information table. When the identification information of the drawing apparatus that is emitting light is estimation information (YES at step S608), the process ends. When the identification information of the drawing apparatus that is emitting light is not estimation information (NO at step S608), the process proceeds to step S609.

At step S609, the drawing apparatus information evaluation unit 306 changes the state of the identification information of the drawing apparatus that is emitting light from an initial state of “NOT CONFIRMED” to “ESTIMATED,” as illustrated in table 640 in FIG. 6BB. At step S610, the drawing apparatus information evaluation unit 306 sets the estimation flag to “ON,” and the process ends. When the process ends, the drawing apparatus is turned off.

Therefore, the behavior of the drawing apparatus becomes “END DRAWING” and the emission state of drawing apparatus becomes “NOT EMITTING,” as illustrated in table 650 in FIG. 6BB. Further, the state of the ID of the drawing apparatus becomes “CONFIRMED,” as illustrated by table 650 in FIG. 6BB. Additionally, if the process is the reset state due to the end of drawing, the state is changed, as shown in the table 660.

When the estimation flag is set to “ON,” the verification process of identification information of the drawing apparatus (FIG. 7) is performed regarding the identification information of the drawing apparatus. This process is performed to prevent inconsistency between the real emission state of the drawing apparatus and that stored in the drawing apparatus information table.

FIG. 7 is a flowchart illustrating one embodiment for verification of the identification information of the drawing apparatus according to the present disclosure. By referring to FIG. 7, the verification process of the identification information of the drawing apparatus, which is performed when the estimation flag is on, is described.

At step S701, the estimation information verification unit 313 determines whether or not consistency in number is established by determining whether a match exists in a number of identification information of the drawing apparatus registered in the drawing apparatus information table as estimation information (as identified through the imaging apparatuses) and a number of identification information of the drawing apparatus received through wireless communication in a predetermined time period before performing step 701. When consistency of the numbers is not established (NO at step S701), the process of step S701 is performed iteratively. On the other hand, when consistency of the numbers is established (YES at step S701), the process proceeds to step S702.

At step S702, the estimation information verification unit 313 determines whether or not the estimation of identification information of the drawing apparatus is erroneous. In more detail, the estimation information verification unit 313 determines that estimation of identification information of the drawing apparatus is not erroneous when a difference between the capturing time associated with the identification information of the drawing apparatus registered in the drawing apparatus information table as estimation information and the receiving time of identification information of the drawing apparatus received from the drawing apparatus 130 used as determining at step S701 is within a predetermined time.

In one embodiment, two average times are used in step S702. One average time is the average receiving time from when the drawing apparatus 130 emits light and sends identification information of the drawing apparatus, to when the image process device 110 receives the identification information of the drawing apparatus. The other average time is the average capturing time from when the imaging apparatuses detect emission of light using the captured images, to when identification information of the drawing apparatus is registered as estimation information in the drawing apparatus information table, according to the process illustrated in FIG. 5A and FIG. 5B. The estimation information verification unit 313 determines that estimation of identification information of the drawing apparatus is not erroneous when a difference between the average capturing time and the average receiving time is less that the predetermined time.

When there is a problem in the estimation of the identification information of the drawing apparatus (YES at step S702), the process proceeds to step S703. At step S703, the estimation information verification unit 313 replaces the identification information of the drawing apparatus registered in the drawing apparatus information table as estimation information to the predetermined other identification information of the drawing apparatus, and the process returns to step S701.

In one embodiment, the estimation information verification unit 313 replaces the identification information of the drawing apparatus that is erroneous by using the other identification information of the drawing apparatus when the other identification information of the drawing apparatus registered in the drawing apparatus information table as estimation information exists. On the other hand, when the other identification information of the drawing apparatus registered in the drawing apparatus information table as estimation information does not exist, the estimation information verification unit 313 replaces the identification information of the drawing apparatus that is erroneous by using predetermined identification information of the drawing apparatus.

At step S702, when determining that there is no problem regarding the estimation of identification information of the drawing apparatus (NO at step S702), the process proceeds to step S704. At step S704, the estimation information verification unit 313 changes the state of the identification information of the drawing apparatus, for which it is determined that there is no problem with the estimation, from “ESTIMATED” to “CONFIRMED,” updates the drawing apparatus table, and sets the estimation flag to “off” at step 705, as shown in the drawing apparatus information table 830 of FIG. 8. As a result, the reliability of identification information of the drawing apparatus is improved.

At step S706, the drawing erasing unit 308 refers to the setting information table, and determines whether or not erasing is set as setting information associated with the identification information of the drawing apparatus. When the erasing is not set (NO at step S706), the process ends. On the other hand, when erasing is set (YES at step S706), the process proceeds to step S513.

At step S707, the drawing erasing unit 308 refers to the drawing apparatus information table, and deletes the drawing image coordinates associated with the identification information of the drawing apparatus, and the process ends.

FIG. 8 is a figure illustrating a state transition for one embodiment of the drawing apparatus information table. In the drawing apparatus information table, when the capturing image is generated, the capturing time of the captured image is registered, as illustrated in the drawing apparatus information table 800. In one embodiment, the initial value of the state of the drawing apparatus is “NOT EMITTING.”

Next, as shown in the drawing apparatus information table 810, the coordinates at which the drawing apparatus emits light in the capturing image is registered. Further, as shown in the drawing apparatus information table 820, the immediate identification information of the drawing apparatus or predetermined identification information of the drawing apparatus is registered as estimation information. As shown in the drawing apparatus information table 830, the state of the drawing apparatus changes from “NOT EMITTING” to “EMITTING”. Further, the verification process of the identification information of the drawing apparatus illustrated by FIG. 7 is performed, while when the estimation of identification information of the drawing apparatus is determined to not have a problem, such as illustrated by the drawing apparatus information table 840, the state of identification information of the drawing apparatus changes from “ESTIMATED” to “CONFIRMED.”

FIG. 9A and FIG. 9B are figures for one embodiment of setting the information table and the receiving information table. The setting information is registered in association with identification information of the drawing apparatus. In the receiving information table, such as shown in FIG. 9B, a receiving time, received identification information from the drawing apparatus 130, the identification information of the drawing apparatus, and identification information of the drawing apparatus that emitted light are registered in association with one another.

Specific embodiments of the present disclosure have been described. However, the present disclosure is not limited to the embodiments described above. It is possible to change the disclosed embodiments within the range that can occur to those skilled in the art, such as changing or deleting components of the embodiments described above or adding other components to components of the embodiments described above, etc.

1. An image processing system, comprising:
processing circuitry configured to
calculate coordinates of a drawing apparatus adjacent to or contacting a display;
determine identification information of the drawing apparatus based on the calculated coordinates; and
draw an image at the calculated coordinates based on setting information that corresponds to the identification information of the drawing apparatus.

2. The image processing system according to claim 1, wherein the processing circuitry is further configured to verify the identification information of the drawing apparatus.

3. The image processing system according to claim 1, further comprising:
a display controller configured to display a message related to the drawing performed by the processing circuitry.

4. An image processing apparatus that draws an image based on a drawing apparatus contacting a display, the image processing apparatus comprising:
processing circuitry configured to p2 calculate coordinates of the drawing apparatus;
determine identification information of the drawing apparatus based on the calculated coordinates; and
draw an image at the calculated coordinates based on setting information that corresponds to identification information of the drawing apparatus.

5. The image processing apparatus according to claim 4, wherein the processing circuitry is further configured to verify the identification information.

6. The image processing apparatus according to claim 4, further comprising:
a display controller configured to display a message related to the drawing performed by the drawing apparatus.

7. An image processing method for drawing an image based on a drawing apparatus contacting an a display, the method comprising:
calculating coordinates of the drawing apparatus;
determine identification information of the drawing apparatus based on the calculated coordinates; and
drawing an image at the calculated coordinates based on setting information that corresponds to the identification information of the drawing apparatus.

8. The method of claim 7, further comprising:
verifying the identification information.

9. The method of claim 7, further comprising:
displaying a message related to drawing by the drawing apparatus.
